(19) United States
(12) Patent Application Publication
(10) Pub. No.: US 2011/0099885 A1
(43) Pub. Date: May 5, 2011

(54) Flying Insect Trap

(76) Inventor: Mwandacha Ezekiel Maganga, Aldergrove (CA)

(21) Appl. No.: 12/806,200

(22) Filed: Sep. 22, 2009

(51) Int. Cl. A01M 1/10; A01M 1/22; A01M 1/04

(52) U.S. Cl. 43/112; 43/122; 43/113

(57) ABSTRACT

A trap for catching flying insects having a clear outer shell with a removable top lid, a fixed or removable bottom lid and an entry conduit mounted on the top lid is disclosed. The entry conduit comprising of a polygonal cross section extending from the proximity of the top lid to the proximity of the bottom lid is contained within outer shell. The entry conduit is open at both the top and bottom ends to provide a passage for flying insect into the cavity around the conduit. The space between the bottom end of the conduit and the bottom lid of the outer shell contains bait for attracting insects. The outer surface of the conduit is coated with a sticky substance, insecticide, acaricide, electrocuting grid or any other means of immobilizing or killing insects entering the cavity. The lid can be removed for easy cleaning, replacement of the conduit and refilling with bait. The bait may includes organic, non-toxic and non-hazardous material alone or in combination with a device for emitting light or sound, which can be safely installed on, under or near the bottom lid of the device for the purpose of attracting insects.

### REFERENCES CITED

U.S. Patent Documents

| | | |
|---|---|---|
| 4,217,722 | August 1980 | McMullen |
| 4,244,135 | January 1981 | Harwoods |
| 4,551,941 | November 1985 | Schneidmiller |
| 4,794,724 | January 1989 | Peters |
| 5,243,781 | September 1993 | Carter |
| 5,461,822 | October 1995 | Green, et al. |
| 6,546,667 | April 2003 | Carter |

Foreign Patent Documents

| | | |
|---|---|---|
| 19292 | November 1930 | AU |
| 744269 | April 1933 | FR |

### BACKGROUND OF THE INVENTION

This invention relates to flying insect traps and specifically to sticky baited traps for monitoring or eliminating flying insects,

Flying insects are annoying and can potentially contaminate food, feed and food contact surfaces, hence the need to eliminate them especially around animal housing facilities, food processing plants, food service areas and homes.

Different means of trapping flying insect have been suggested to help provide relief from their nuisance. A number of sticky traps of various shapes have been proposed for suspension on ceilings and other elevated objects or for placement on window seals. U.S. Pat. No. 5,815,981 to Dowling, et al. describes one such trap. Other traps comprise of a sticky trapping panel contained in a light-emitting device with or without an electrocuting grid. Yet other traps such as described in U.S. Pat. No. 5,243,781 to Carter attract insects into a receiving and retaining chamber using various mixtures of organic and inorganic substances.

This invention improves the present existing traps by being made of clear shell and an entry conduit leading flying insects into a baited chamber from where insects are immobilized on the exterior surface of the conduit or killed using an insecticide applied on the said conduit surface.

This trap can be placed on a flat surface containing at attractive substance such as fruits on a table. Various researchers have formulated lures to attract flying insects that can be placed on the bottom lid of the trap where a lid is provided or on a container on the flat surface under the trap when the bottom lid is not provided.

### DESCRIPTION OF PRIOR ART

Below is a list of patent numbers which relate to flying insect traps and other insect traps resembling my trap: U.S. Pat. No. 6,546,667 Date: Apr. 15, 2003, U.S. Pat. No. 5,461,822 Date: Oct. 31, 1995, U.S. Pat. No. 5,243,781 Date: Sep. 14, 1993, U.S. Pat. No. 4,794,724 Date: Jan. 3, 1989, U.S. Pat. No. 4,551,941 Date: Nov. 12, 1985, U.S. Pat. No. 4,244,135 Date: Jan. 13, 1981, U.S. Pat. No. 4,217,722 Date: Aug. 19, 1980.

In addition to the above listed, a number of patent application numbers listed below describe other resembling insect traps: U.S. Pat. Appl. No. 20090183419 Date: Jul. 23, 2009, U.S. Pat. Appl. No. 20090151228 Date: Jun. 18, 2009, U.S. Pat. Appl. No. 20090126257 Date: May 21, 2009, U.S. Pat. Appl. No. 20090094883 Date: Apr. 16, 2009, U.S. Pat. Appl. No. 20080229652 Date: September 2008, U.S. Pat. Appl. No. 20080168702 Date: July 2008.

### SUMMARY OF THE INVENTION

It is therefore the object of the present invention to provide a trap for flying insects. It is further the object of this invention to increase the number of insects entering the trap by using an entry conduit with a uniform polygonal cross section.

An advantageous aspect of the flying insects trap according to the invention includes the use of a sticky substance or an insecticide or an electrocuting grid on the exterior convex surface of the entry conduit for immobilizing or killing trapped insects

### BRIEF DESCRIPTION OF DRAWINGS

The invention will be more fully understood when considered with the following detailed description and the attached drawings in Appendix 1. In the drawings and throughout this application, like parts are designated by like reference numerals. The drawings are briefly described as follows:

FIG. 1 is a perspective view of the preferred flying insect trap according to the invention.

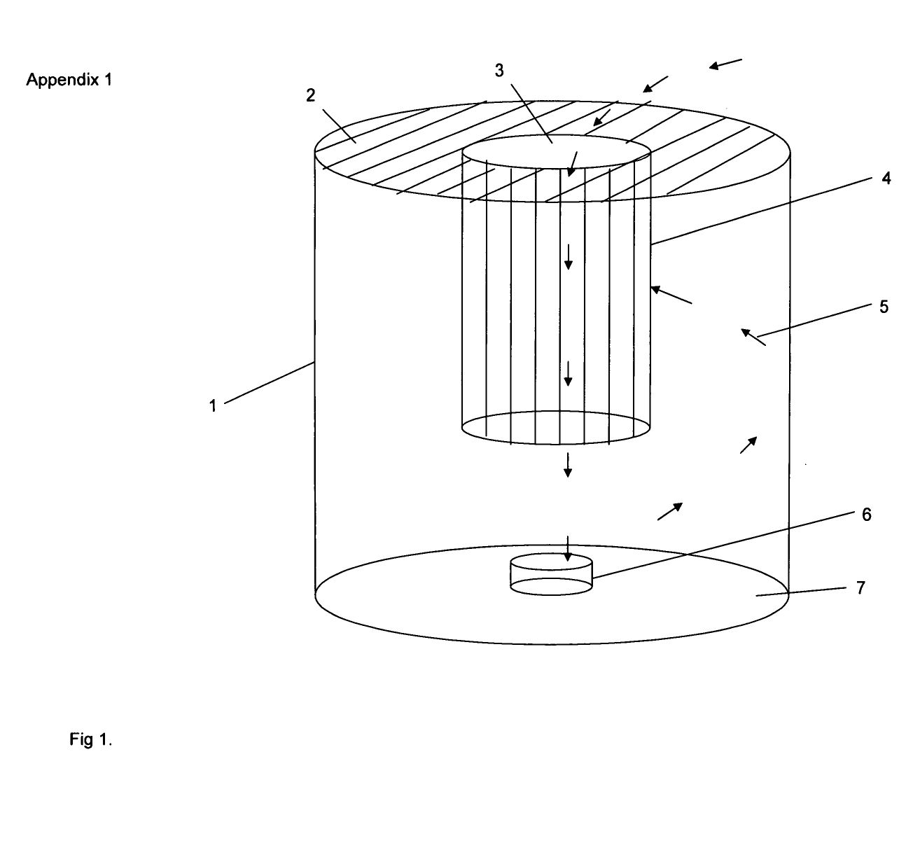

FIG. 2 is the cross section taken anywhere along the length of the trap where the entry conduit exists.

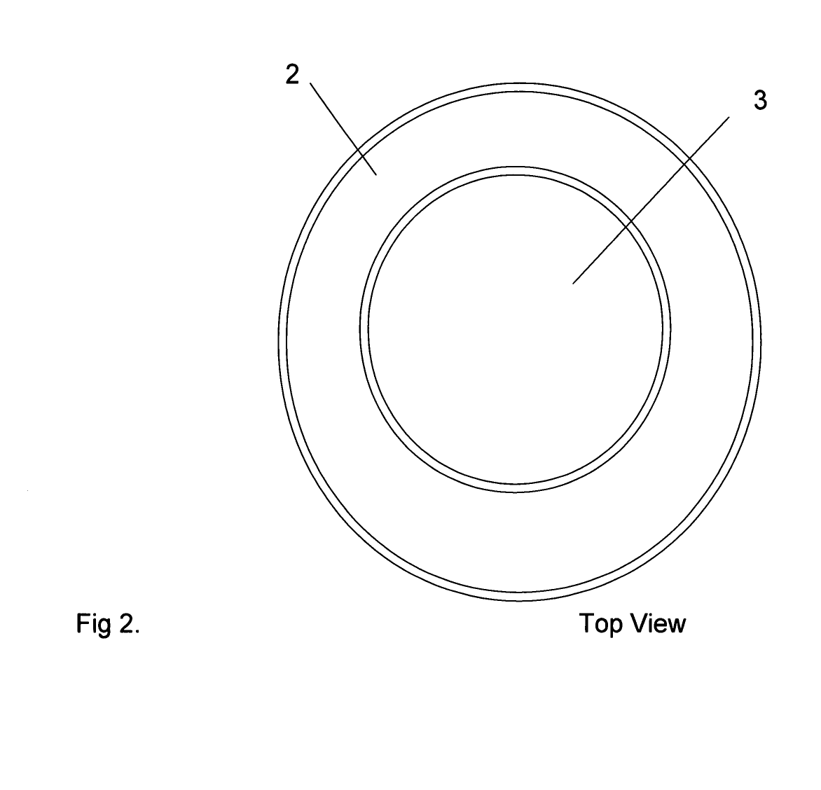

FIG. 3 is a longitudinal section across the medial diameter of the trap

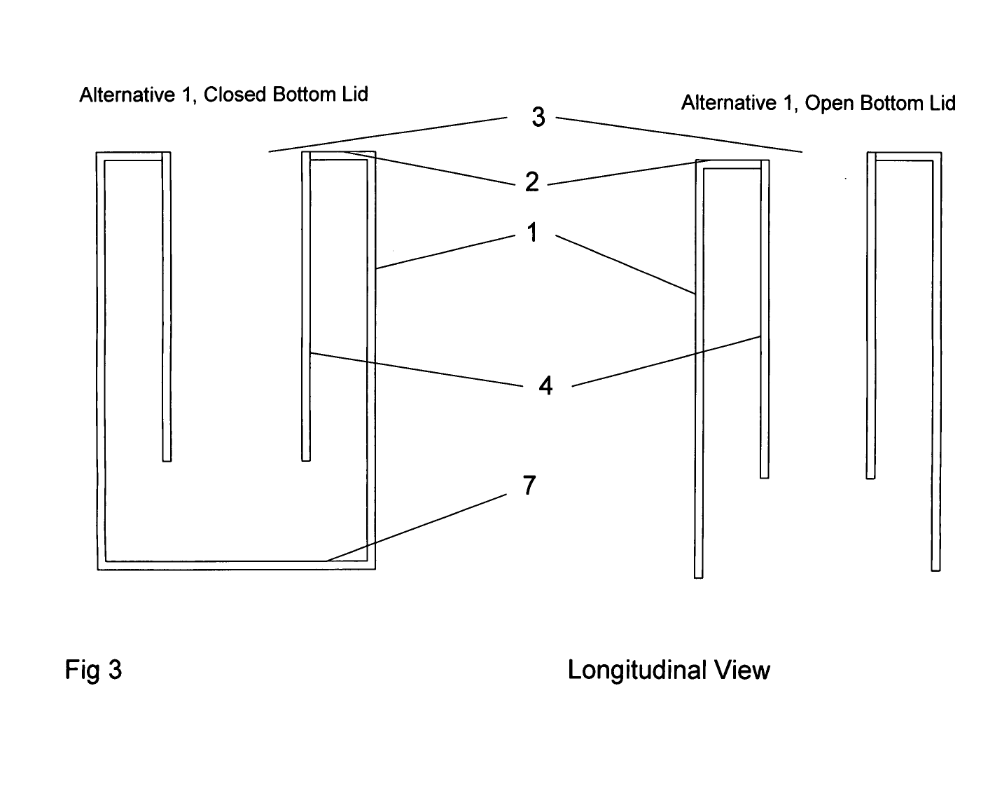

### DESCRIPTION OF PREFERRED EMBODIMENT

The outer shell (1) is made of a transparent or semi-transparent material that allows light to shine through the insect receiving and retaining chamber containing bait placed on the bottom lid of the shell. Flying insects attracted by the bait to the top lid (2) of the shell enter the retaining chamber through a polygonal conduit (3). Upon landing and feeding on the bait, insects are attracted to the sides of the shell by incoming light from ambient sources or from an installed light source around the exterior of the shell. Insects flying around inside the chamber are either trapped on the adhesive-coated outer surface of the polygonal conduit (4) or killed by an insecticide applied on the surface of the conduit or shell. The anticipated movement of flying insects is depicted by arrows (5). Suitable attractive bait, preferably a non-toxic and non-hazardous substance is placed in a container (6) on the bottom lid of the shell (7) if such a lid is provided or placed on a flat surface such as a table when the bottom lid is not provided and the entire device fully or partially rests on the flat surface.

I claim:

1. A flying insect trap comprising:
a transparent or semi-transparent vertical outer shell defining an interior cavity for receiving and retaining trapped flying insects, said shell comprising of a rigid or flexible top and bottom lids, said upper lid furnished with an opening for receiving an entry conduit having both ends open to allow flying insects ingress into the said cavity;
an entry conduit with a polygonal cross-section mounted on the top lid of the said shell having an opening at both the upper and lower end, said conduit further comprising a means of securing its upper fixed or removable end to the said opening of top lid, said entry conduit extending from the proximity of the upper lid to the proximity of the bottom lid and furnished with a means for immobilizing or killing trapped insects on its outer convexity;
a means of attracting insects into the interior cavity of the trap.

2. The device of claim 1, wherein said shell lacks a bottom lid and wherein said open bottom end of the outer shell rests on a flat surface furnished with a means of attracting insects.

3. The device of claim 1, wherein said polygonal cross section of the said entry conduit ranges from a triangular shape to a circle providing a conduit who shape ranges from a tubular body with a triangular cross section to a tubular body with a circular cross section including any other number of sides for the cross-section of the polygon between these two extremes.

4. The device of claim 1, wherein said means of immobilizing or killing trapped flying insects includes but is not limited to a sticky substance, an insecticide, an acaricide or an electrocuting surface.

5. The device of claim 1, wherein said means of attracting flying insects includes but is not limited to an organic non-toxic, non-hazardous substance with or without further mean of attracting flying insects including but not limited to devices emitting light and sound.

6. The device in claim 1, wherein said means of attracting flying insects can be safely placed on, under or near the proximity of the bottom lid.

7. The device of claim 2 wherein the said means of attracting flying insects can be safely placed or installed on or under the flat surface upon which the outer shell of the device rests.
